(19) United States
(12) Patent Application Publication
(10) Pub. No.: US 2025/0350937 A1
(43) Pub. Date: Nov. 13, 2025

(54) SECURE UPLINK COMMUNICATION IN AMBIENT INTERNET OF THINGS ARCHITECTURE

(71) Applicant: QUALCOMM Incorporated, San Diego, CA (US)

(72) Inventors: Hongil KIM, San Diego, CA (US); Soo Bum LEE, San Diego, CA (US)

(21) Appl. No.: 19/184,348

(22) Filed: Apr. 21, 2025

Related U.S. Application Data
(60) Provisional application No. 63/645,394, filed on May 10, 2024.

(51) Int. Cl. H04W 12/0431; H04W 12/041; H04W 12/106

(52) U.S. Cl. CPC H04W 12/0431; H04W 12/041; H04W 12/106

(57) ABSTRACT

Various aspects of the present disclosure generally relate to wireless communication. In some aspects, an ambient Internet of Things (AIoT) device may generate a protected message using a protection key, where the protection key is derived using a provisioned device credential and a key derivation parameter. The AIoT device may transmit the protected message, via an AIoT reader, for delivery to an application function. Numerous other aspects are described.

### CROSS-REFERENCE TO RELATED APPLICATION

This Patent Application claims priority to U.S. Provisional Patent Application No. 63/645,394, filed on May 10, 2024, entitled “SECURE UPLINK COMMUNICATION IN AMBIENT INTERNET OF THINGS ARCHITECTURE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for secure uplink communication in ambient Internet of Things architecture.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support IoT and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by an ambient Internet of Things (AIoT) device. The method may include generating a protected message using a protection key, wherein the protection key is derived using a provisioned device credential and a key derivation parameter. The method may include transmitting the protected message, via an AIoT reader, for delivery to an application function.

Some aspects described herein relate to a method of wireless communication performed by an AIoT controller. The method may include receiving a protected message, via an AIoT reader, from an AIoT device. The method may include generating a verified message, from the protected message, using a protection key, wherein the protection key is derived using a provisioned device credential and a key derivation parameter. The method may include transmitting the verified message to an application function.

Some aspects described herein relate to an apparatus for wireless communication at an AIoT device. The apparatus may include one or more memories and one or more processors coupled to the one or more memories. The one or more processors may be configured to generate a protected message using a protection key, wherein the protection key is derived using a provisioned device credential and a key derivation parameter. The one or more processors may be configured to transmit the protected message, via an AIoT reader, for delivery to an application function.

Some aspects described herein relate to an apparatus for wireless communication at an AIoT controller. The apparatus may include one or more memories and one or more processors coupled to the one or more memories. The one or more processors may be configured to receive a protected message, via an AIoT reader, from an AIoT device. The one or more processors may be configured to generate a verified message, from the protected message, using a protection key, wherein the protection key is derived using a provisioned device credential and a key derivation parameter. The one or more processors may be configured to transmit the verified message to an application function.

Some aspects described herein relate to a non-transitory computer-readable medium that stores a set of instructions for wireless communication by an AIoT device. The set of instructions, when executed by one or more processors of the AIoT device, may cause the AIoT device to generate a protected message using a protection key, wherein the protection key is derived using a provisioned device credential and a key derivation parameter. The set of instructions, when executed by one or more processors of the AIoT device, may cause the AIoT device to transmit the protected message, via an AIoT reader, for delivery to an application function.

Some aspects described herein relate to a non-transitory computer-readable medium that stores a set of instructions for wireless communication by an AIoT controller. The set of instructions, when executed by one or more processors of the AIoT controller, may cause the AIoT controller to receive a protected message, via an AIoT reader, from an AIoT device. The set of instructions, when executed by one or more processors of the AIoT controller, may cause the AIoT controller to generate a verified message, from the protected message, using a protection key, wherein the protection key is derived using a provisioned device credential and a key derivation parameter. The set of instructions, when executed by one or more processors of the AIoT controller, may cause the AIoT controller to transmit the verified message to an application function.

Some aspects described herein relate to an apparatus for wireless communication. The apparatus may include means for generating a protected message using a protection key, wherein the protection key is derived using a provisioned device credential and a key derivation parameter. The apparatus may include means for transmitting the protected message, via an AIoT reader, for delivery to an application function.

Some aspects described herein relate to an apparatus for wireless communication. The apparatus may include means for receiving a protected message, via an AIoT reader, from an AIoT device. The apparatus may include means for generating a verified message, from the protected message, using a protection key, wherein the protection key is derived using a provisioned device credential and a key derivation parameter. The apparatus may include means for transmitting the verified message to an application function.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment in a wireless network, in accordance with the present disclosure.

FIG. 3 is a diagram illustrating an example ambient Internet of Things (AIoT) architecture, in accordance with the present disclosure.

FIG. 4 is a diagram illustrating an example associated with a device originated communication in AIoT architecture, in accordance with the present disclosure.

FIG. 5 is a diagram illustrating an example associated with a command response in AIoT architecture, in accordance with the present disclosure.

FIGS. 6 and 7 are diagrams illustrating example processes associated with secure uplink communications in AIoT architecture, in accordance with the present disclosure.

FIGS. 8 and 9 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In an ambient Internet of Things (AIoT) architecture, an AIoT device may be used for inventory, sensor measurements, or package tracking, among other examples. The AIoT device may communicate with an AIoT reader (e.g., at a checkpoint or periodically). The AIoT reader may communicate with an AIoT controller to report detected AIoT devices with enrichment data (e.g., Global Navigation Satellite System (GNSS) location and/or a neighbor cell identifier (ID), among other examples) and relay commands. Accordingly, the AIoT controller may communicate with an application function (e.g., deployed by a service provider for the AIoT service).

Communications from the AIoT controller to the AIoT device (e.g., via the AIoT reader) may be secured using a credential provisioned for the AIoT controller (e.g., by the application function). However, communications from the AIoT device to the AIoT controller (e.g., via the AIoT reader) may be unsecure. For example, the communications may be intercepted by bad actors. Additionally, or alternatively, a bad actor may transmit phony communications to the AIoT controller (e.g., to attack the AIoT infrastructure or otherwise corrupt data at the application function).

Various aspects relate generally to using a protection key generate a protected message transmitted from an AIoT device to an AIoT controller. Some aspects more specifically relate to deriving the protection key using a provisioned device credential and a key derivation parameter. In some aspects, a confidentiality protection key may be generated from the protection key in order to encrypt the message. In some aspects, an integrity protection key may be generated from the protection key in order to verify the message.

Particular aspects of the subject matter described in this disclosure can be implemented to realize one or more of the following potential advantages. In some examples, because the message is protected using the protection key, the described techniques can be used to improve security between the AIoT device and the AIoT controller. In some examples, because the message is encrypted using the confidentiality protection key, the message is protected from interception. In some examples, because the message is verified using the integrity protection key, the AIoT controller may detect and reject phony communications (e.g., to attack the AIoT controller or otherwise corrupt data at the application function).

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, IoT connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) user equipment (UE) functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

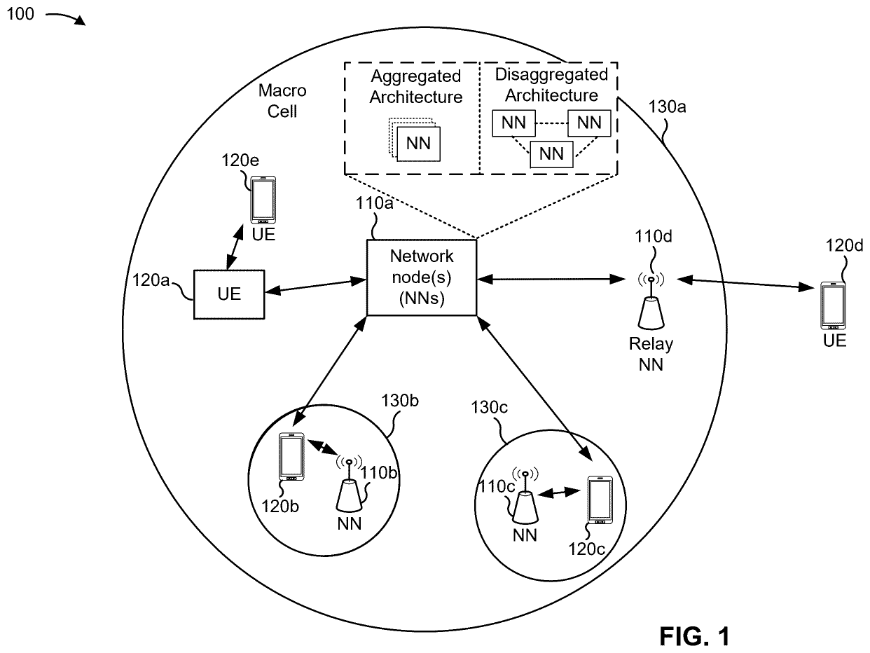

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FRI is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a GNSS device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

As indicated above, FIG. 1 is provided as an example. Other examples may differ from what is described with regard to FIG. 1.

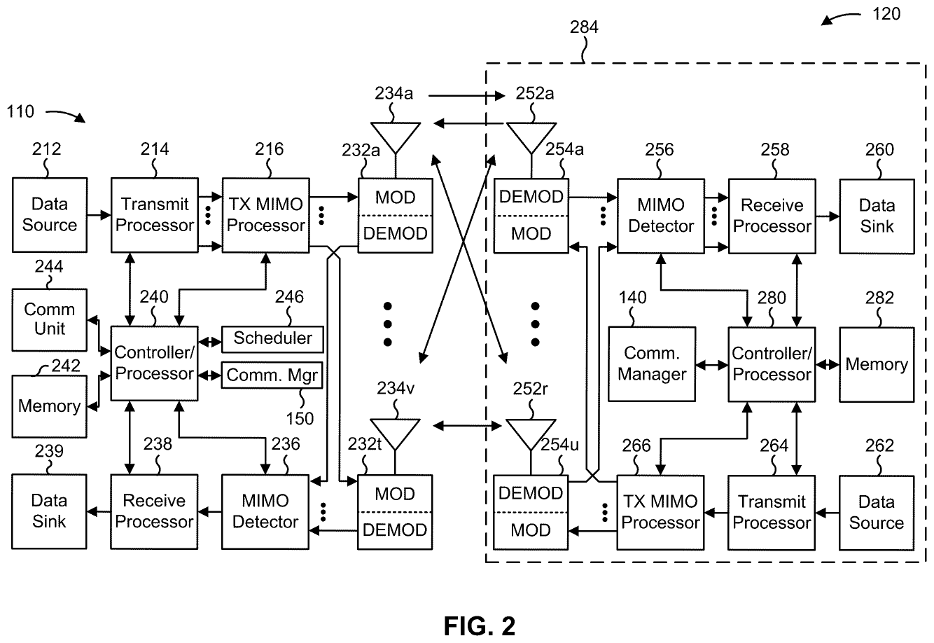

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and control schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

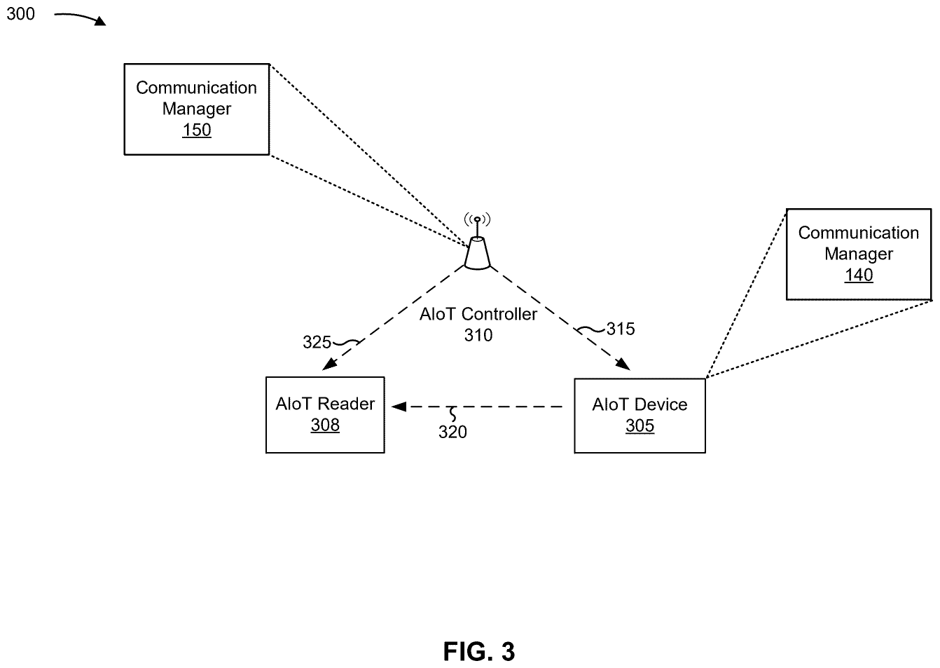

FIG. 3 is a diagram illustrating an example 300 of an AIoT architecture, in accordance with the present disclosure. Some wireless communication devices may be considered IoT devices, such as AIoT devices (sometimes referred to as ultra-light IoT devices), or similar IoT devices.

AIoT devices may be categorized into at least three types of devices: device 1, device 2a, and device 2b. Device 1 type AIoT devices may include at least some passive and/or semi-passive devices. A device 1 type AIoT device may have approximately 1 micro Watt (μW) peak power consumption, support energy storage, use an initial sampling frequency offset (SFO) up to 10X parts per million (ppm) (for example, where X can be any suitable value), and communicate uplink transmissions by backscattering externally-provided continuous waves (CWs).

Device 2a type AIoT devices may include at least some semi-passive devices, and device 2b type AIoT devices may include active devices. Both device 2a and device 2b type AoT devices may have less than or equal to a few hundred μW peak power consumption, support energy storage, and use an initial SFO up to 10X ppm. A device 2a type AIoT device may communicate uplink transmissions by backscattering externally-provided CWs. A device 2b type AIoT device may communicate uplink transmissions by internally generating the uplink transmission.

In some examples, device 1, device 2a, and/or device 2b type AIoT devices that are located indoors may support a maximum distance of 10-50 meters, a range which may be sub-selected. In Topology 1 (for example, in which an AIoT device may directly and bidirectionally communicate with one or more network nodes 110) and in Topology 2 (for example, in which an AIoT device may communicate bidirectionally with an intermediate node between the AIoT device and a network node 110), device 1, device 2a, and/or device 2b type AIoT devices may not support RRC states, mobility (for example, cell-selection/re-selection-like functionality), automatic repeat request (ARQ), or hybrid ARQ (HARQ).

In AIoT, a terminal (for example, an radio frequency identification (RFID) device, a tag, or a similar device) may not include a battery, and the terminal may accumulate energy from radio signaling. To achieve further cost reduction and zero-power communication, wireless networks may utilize a type of AIoT device referred to as an “ambient backscatter device” or a “backscatter device.”

As shown in FIG. 3, an AIoT device 305 (for example, a tag or a sensor, among other examples), which may be one example of an AIoT device, such as a passive, semi-passive, or active ambient IoT device described above, may employ a simplified hardware design (for example, including a power splitter, an energy harvester, and a microcontroller) that does not include a battery, such that the AIoT device 305 relies on energy harvesting for power, and that does not include a radio wave generation circuit, such that the AIoT device 305 is capable of transmitting information only by reflecting a radio wave. More particularly, the AIoT device 305 communicates with an AIoT reader 308 (for example, a UE 120, a network node 110, or another network device) by modulating a reflecting radio signal from an AIoT controller 310 (for example, a network node 110, a UE 120, or another network device). In some examples, the AIoT controller 310 and the AIoT reader 308 may be the same device and/or may be co-located. For example, in some instances, the AIoT reader 308 and the AIoT controller 310 may be associated with the same network node 110. The AIoT controller 310 may communicate with the AIoT device 305 over a broadcast link 315. The AIoT device 305 may communicate with the AIoT reader 308 over a link 320, and the AIoT reader 308 and the AIoT controller 310 may communicate over a link 325.

In some aspects, the AIoT device 305 may include a communication manager 140. As described in more detail elsewhere herein, the communication manager 140 may generate a protected message using a protection key, where the protection key is derived using a provisioned device credential and a key derivation parameter, and may transmit the protected message, via the AIoT reader 308, for delivery to an application function. Additionally, or alternatively, the communication manager 140 may perform one or more other operations described herein.

In some aspects, the AIoT controller 310 may include a communication manager 150. As described in more detail elsewhere herein, the communication manager 150 may receive a protected message, via an AIoT reader 308, from an AIoT device 305; may generate a verified message, from the protected message, using a protection key, where the protection key is derived using a provisioned device credential and a key derivation parameter; and may transmit the verified message to an application function. Additionally, or alternatively, the communication manager 150 may perform one or more other operations described herein.

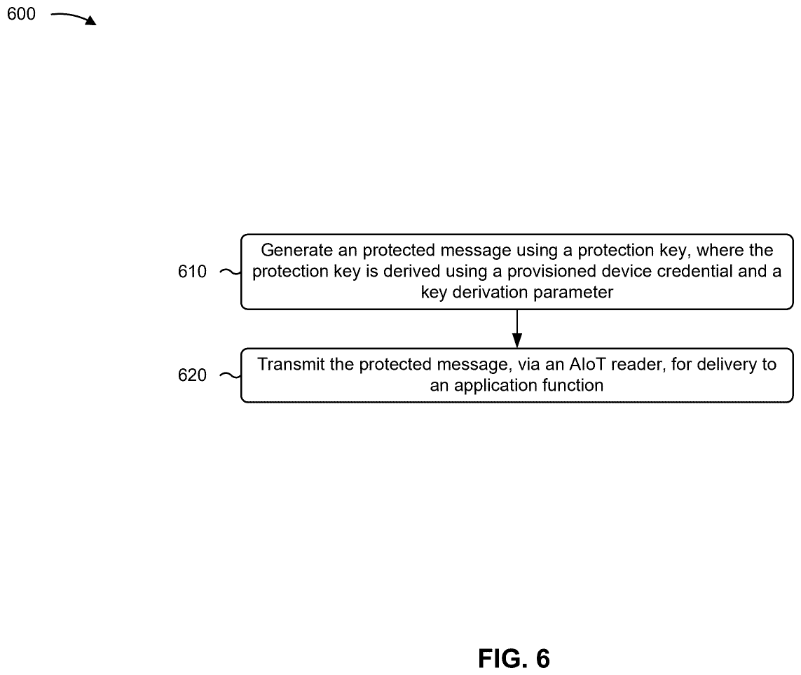

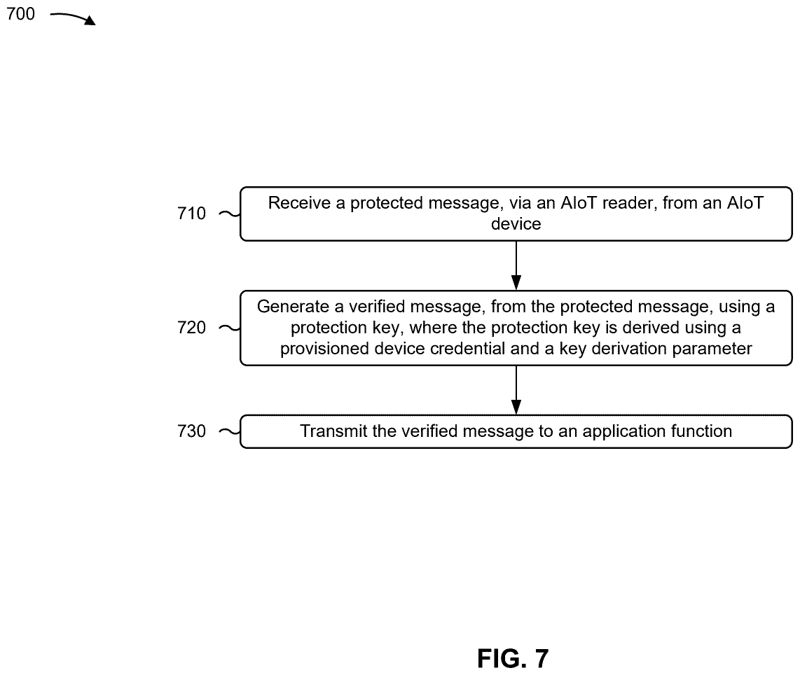

The network node 110, the controller/processor 240 of the network node 110, the UE 120, the controller/processor 280 of the UE 120, the AIoT device 305, the AIoT reader 308, the AIoT controller 310, or any other component(s) of FIG. 1, 2, or 3 may implement one or more techniques or perform one or more operations associated with secure uplink communication in AIoT architecture, as described in more detail elsewhere herein. For example, the controller/processor 240 of the network node 110, the controller/processor 280 of the UE 120, any other component(s) of FIG. 2, the AIoT device 305, the AIoT reader 308, or the AIoT controller 310, may perform or direct operations of, for example, process 600 of FIG. 6, process 700 of FIG. 7, or other processes as described herein (alone or in conjunction with one or more other processors). The memory 242 may store data and program codes for the network node 110, the network node 110, the AIoT device 305, the AIoT reader 308, or the AIoT controller 310,. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the AIoT device 305, the AIoT reader 308, or the AIoT controller 310, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples. In some aspects, the AIoT device and/or the AIoT controller described herein is the UE 120, is included in the UE 120, or includes one or more components of the UE 120 shown in FIG. 2. Additionally, or alternatively, the AIoT controller described herein is the network node 110, is included in the network node 110, or includes one or more components of the network node 110 shown in FIG. 2.

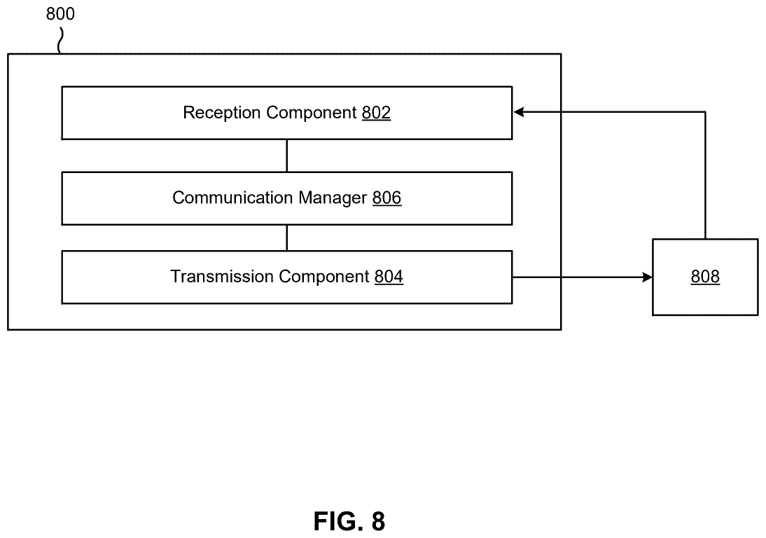

In some aspects, a AIoT device (e.g., AIoT device 305 and/or apparatus 800 of FIG. 8) may include means for generating a protected message using a protection key, wherein the protection key is derived using a provisioned device credential and a key derivation parameter; and/or means for transmitting the protected message, via an AIoT reader, for delivery to an application function. In some aspects, the means for the AIoT device to perform operations described herein may include, for example, one or more of communication manager 140, antenna 252, modem 254, MIMO detector 256, receive processor 258, transmit processor 264, TX MIMO processor 266, controller/processor 280, or memory 282.

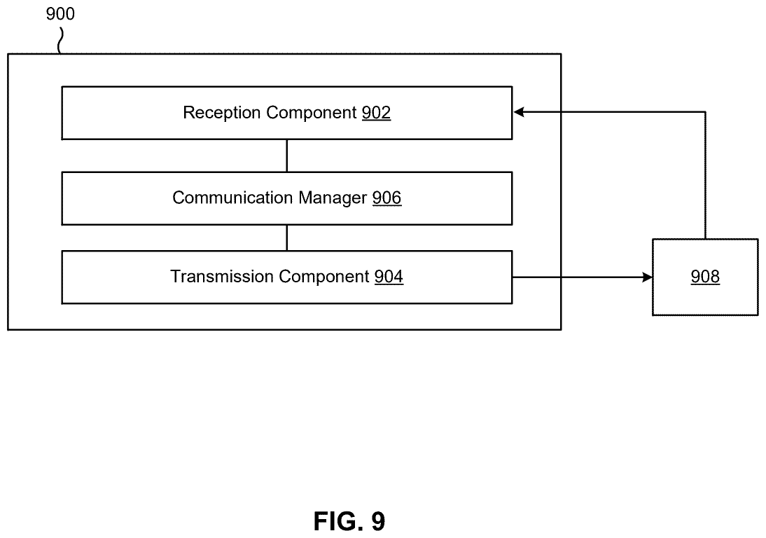

In some aspects, an AIoT controller (e.g., AIoT controller 310 and/or apparatus 900 of FIG. 9) may include means for receiving a protected message, via an AIoT reader, from an AIoT device; means for generating a verified message, from the protected message, using a protection key, wherein the protection key is derived using a provisioned device credential and a key derivation parameter; and/or means for transmitting the verified message to an application function. In some aspects, the means for the AIoT controller to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246. Additionally, or alternatively, the means for the AIoT controller to perform operations described herein may include, for example, one or more of communication manager 140, antenna 252, modem 254, MIMO detector 256, receive processor 258, transmit processor 264, TX MIMO processor 266, controller/processor 280, or memory 282.

As indicated above, FIG. 3 is provided as an example. Other examples may differ from what is described with regard to FIG. 3.

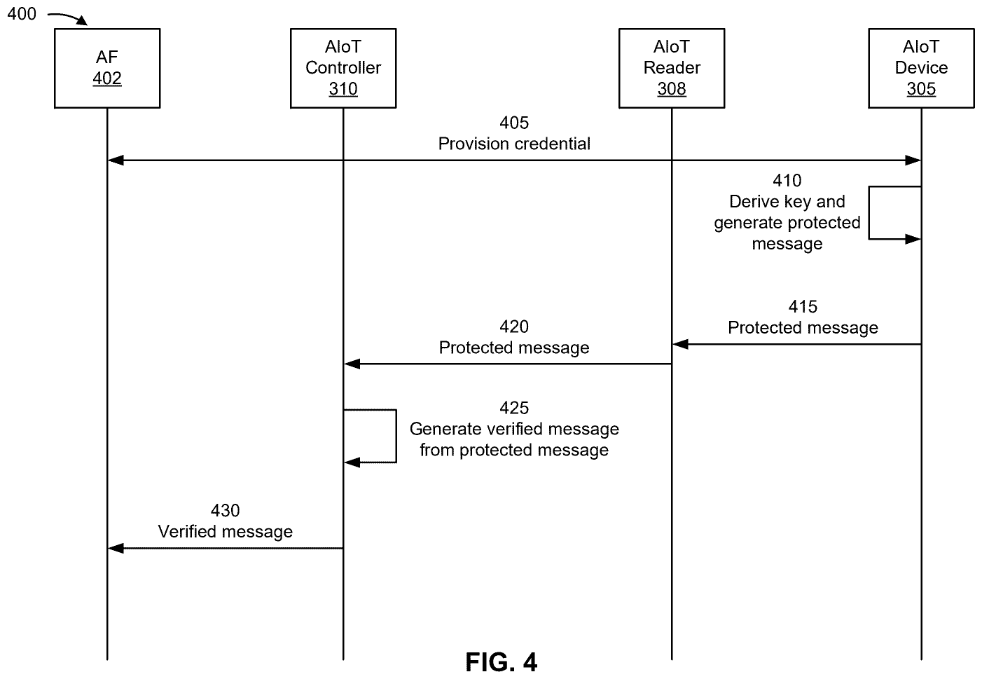

FIG. 4 is a diagram illustrating an example 400 associated with a device originated communication in AIoT architecture, in accordance with the present disclosure. As shown in FIG. 4, an application function (AF) 402, an AIoT controller 310, an AIoT reader 308, and an AIoT device 305 may communicate with one another.

As shown by reference number 405, the AF 402 may provision a credential (e.g., a long-term credential) to the AIoT controller 310 and the AIoT device 305. The credential may be a symmetric key or an asymmetric key. The credential may be a pairwise key associated with the AIoT device 305 or a group key shared with other AIoT devices in addition to the AIoT device 305.

Accordingly, the AIoT controller 310 may derive a key (e.g., represented by K_{AIoT_Controller}) from the provisioned credential and one or more additional parameters. For example, the additional parameters may include a network ID (e.g., a public land mobile network (PLMN) ID or another type of ID associated with a network serving the AF 402). Additionally, or alternatively, the additional parameters may include an ID associated with the AIoT controller 310. Therefore, the AF 402 may provide, to the AIoT controller 310, the key, a lifetime associated with the key (e.g., a freshness parameter), and the ID associated with the AIoT device 305 (e.g., a permanent, or at least long-term, ID) or a group ID associated with a group of AIoT devices (including the AIoT device 305).

The AIoT controller 310 may derive a protection key from the K_{AIoT_Controller} key. For example, the AIoT controller 310 may apply a key derivation function (KDF) to the K_{AIoT_Controller} key along with one or more additional parameters. For example, the additional parameters may include the AIoT controller ID, a service ID (e.g., an ID associated with a service provider using the AF 402), and/or an ID associated with the AIoT device 305. For example, the AIoT device 305 may broadcast the ID or otherwise communicate the ID to the AIoT controller 310 (e.g., via the AIoT reader 308). The protection key may be represented by K_{Command_protection}. In some aspects, the AIoT controller 310 may further derive a confidentiality protection key (e.g., represented by K_{enc}) and/or an integrity protection key (e.g., represented by Kᵢₙₜ) from the protection key.

As shown by reference number 410, the AIoT device 305 may additionally derive the protection key. For example, the AIoT device 305 may receive the network ID in a broadcast message from a network node (e.g., supporting the AF 402), the AIoT controller 310, and/or the AIoT reader 308. The protection key may be represented by K_{AIoTF}. Alternatively, the AIoT device 305 may be programmed (and/or otherwise preconfigured) with the network ID. Similarly, the AIoT device 305 may receive the ID associated with the AIoT controller 310 in a broadcast message from the AIoT controller 310 and/or the AIoT reader 308. Alternatively, the AIoT device 305 may be programmed (and/or otherwise preconfigured) with the ID associated with the AIoT controller 310.

As further shown by reference number 410, the AIoT device 305 may use the protection key to generate a protected message (e.g., for delivery to the AF 402). The protected message may be encrypted (e.g., using the confidentiality protection key). Additionally, or alternatively, the protected message may include an integrity protection key (e.g., generated using the integrity protection key). Additionally, the protection message may include a freshness parameter (e.g., a counter, a time based counter, or a randomly generated number). The freshness parameter may be included in plaintext. Additionally, the protected message may include the network ID, the service ID, and/or the ID associated with the AIoT device 305 in plaintext (e.g., to enable the AIoT controller 310 to derive the protection key).

The protected message may be a device originated message. For example, the protected message may include additional information further to an inventory response, a control message, an acknowledgement (e.g., of a command from the AIoT controller 310), and/or a paging message, among other examples.

As shown by reference number 415, the AIoT device 305 may transmit, and the AIoT reader 308 may receive, the protected message. As shown by reference number 420, the AIoT reader 308 may transmit, and the AIoT controller 310 may receive, the protected message. As shown by reference number 425, the AIoT controller 310 may generate a verified message from the protected message using the protection key. For example, the AIoT controller 310 may decrypt the protected message using the confidential protection key. Additionally, or alternatively, the AIoT controller 310 may verify the protected message using the integrity protection key. In some aspects, the AIoT controller 310 may additionally verify the protected message using the freshness parameter.

As shown by reference number 430, the AIoT controller 310 may transmit, and the AF 402 may receive, the verified message. For example, the AIoT controller 310 may transmit, and the AF 402 may receive, the verified message OTA (e.g., on wireless network 100 of FIG. 1).

Although the example 400 is described in connection with the AF 402, other examples may include an additional function (e.g., an AIoT function (AIoTF)) that performs some of the operations described as performed by the AF 402 in the example 400. For example, the AF 402 may derive the protection key and provide the protection key to the AIoTF to use. Additionally, the AIoTF may communicate with the AIoT device 305 to verify the protected message from the AIoT device 305.

By using techniques as described in connection with FIG. 4, the message is protected using the protection key, which improves security between the AIoT device 305 and the AIoT controller 310. In some examples, the message may be encrypted using the confidentiality protection key, such that the message is protected from interception. In some examples, the message may be verified using the integrity protection key, such that AIoT controller 310 may detect and reject phony communications (e.g., to attack the AIoT controller 310 or otherwise corrupt data at the AF 402).

As indicated above, FIG. 4 is provided as an example. Other examples may differ from what is described with respect to FIG. 4.

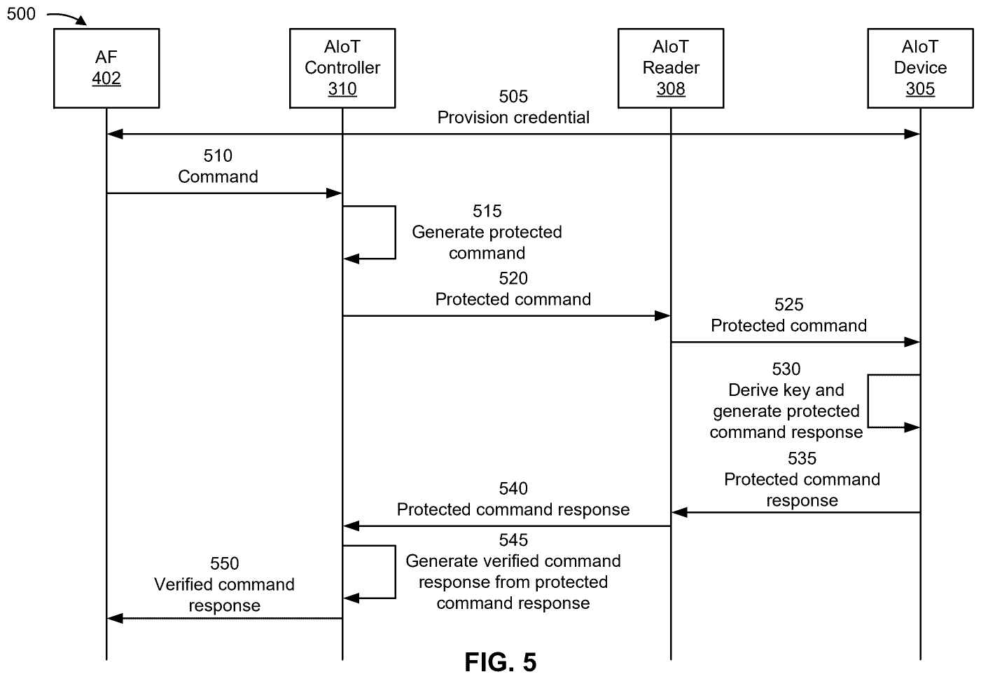

FIG. 5 is a diagram illustrating an example 500 associated with a command response in AIoT architecture, in accordance with the present disclosure. As shown in FIG. 4, an application function 402, an AIoT controller 310, an AIoT reader 308, and an AIoT device 305 may communicate with one another.

As shown by reference number 505, the AF 402 may provision a credential (e.g., a long-term credential) to the AIoT controller 310 and the AIoT device 305. The credential may be a symmetric key or an asymmetric key. The credential may be a pairwise key associated with the AIoT device 305 or a group key shared with other AIoT devices in addition to the AIoT device 305. As described in connection with FIG. 4, the AIoT controller 310 and the AIoT device 305 may derive a protection key (optionally with a confidentiality protection key and/or an integrity protection key).

As shown by reference number 510, the AF 402 may transmit, and the AIoT controller 310 may receive, a command (e.g., for delivery to the AIoT device 305). The command may be a request for an inventory response, a request for a sensor measurement, a control message, or a paging message, among other examples. The AF 402 may transmit, and the AIoT controller 310 may receive, the command OTA (e.g., on wireless network 100 of FIG. 1). Although the example 500 is described in connection with a command, other requests (e.g., an inventory request message) may be used.

As shown by reference number 515, the AIoT controller 310 may use the protection key to generate, from the command, a protected command (e.g., for delivery to the AIoT device 305). The protected command may be encrypted (e.g., using the confidentiality protection key). Additionally, or alternatively, the protected command may include an integrity protection key (e.g., generated using the integrity protection key). Additionally, the protection command may include a freshness parameter (e.g., a counter, a time based counter, or a randomly generated number). The freshness parameter may be included in plaintext. Additionally, the protected command may include the network ID, the service ID, and/or the ID associated with the AIoT controller 310 in plaintext (e.g., to enable the AIoT device 305 to derive the protection key).

As shown by reference number 520, the AIoT controller 310 may transmit, and the AIoT reader 308 may receive, the protected command. As shown by reference number 525, the AIoT reader 308 may transmit, and the AIoT device 305 may receive, the protected command.

As shown by reference number 530, the AIoT device 305 may additionally derive the protection key. For example, the AIoT device 305 may receive the network ID in a broadcast message from a network node (e.g., supporting the AF 402), the AIoT controller 310, and/or the AIoT reader 308. The protection key may be represented by K_{AIoTF}. Alternatively, the protected command may include the network ID in plaintext. Alternatively, the AIoT device 305 may be programmed (and/or otherwise preconfigured) with the network ID. Similarly, the AIoT device 305 may receive the ID associated with the AIoT controller 310 in a broadcast message from the AIoT controller 310 and/or the AIoT reader 308. Alternatively, the protected command may include the ID associated with the AIoT controller 310 in plaintext. Alternatively, the AIoT device 305 may be programmed (and/or otherwise preconfigured) with the ID associated with the AIoT controller 310. In some aspects, the protection key may be derived using the freshness parameter. In some aspects, the protection key may be derived using the freshness parameter included in the protected command as well as an additional freshness parameter generated by the AIoT device 305.

As further shown by reference number 530, the AIoT device 305 may use the protection key to generate a protected command response (e.g., for delivery to the AF 402). The protected command response may be encrypted (e.g., using the confidentiality protection key). Additionally, or alternatively, the protected command response may include an integrity protection key (e.g., generated using the integrity protection key). Additionally, the protection command response may include a freshness parameter (e.g., a counter, a time based counter, or a randomly generated number). The freshness parameter may be included in plaintext. In some aspects, the protection command response may include the freshness parameter included in the protected command as well as an additional freshness parameter generated by the AIoT device 305 (with either or both in plaintext). Although the example 500 is described in connection with a command response, other responses (e.g., an inventory response message) may be used.

As shown by reference number 535, the AIoT device 305 may transmit, and the AIoT reader 308 may receive, the protected command response. As shown by reference number 540, the AIoT reader 308 may transmit, and the AIoT controller 310 may receive, the protected command response. As shown by reference number 545, the AIoT controller 310 may generate a verified command response from the protected command response using the protection key. For example, the AIoT controller 310 may decrypt the protected command response using the confidential protection key. Additionally, or alternatively, the AIoT controller 310 may verify the protected command response using the integrity protection key. In some aspects, the AIoT controller 310 may additionally verify the protected command response using the freshness parameter (and optionally the additional freshness parameter generated by the AIoT device 305).

As shown by reference number 550, the AIoT controller 310 may transmit, and the AF 402 may receive, the verified command response. For example, the AIoT controller 310 may transmit, and the AF 402 may receive, the verified message OTA (e.g., on wireless network 100 of FIG. 1).

Although the example 500 is described in connection with the AF 402, other examples may include an additional function (e.g., an AIoTF) that performs some of the operations described as performed by the AF 402 in the example 400. For example, the AF 402 may derive the protection key and provide the protection key to the AIoTF to use. Additionally, the AIoTF may transmit the protected command to the AIoT device 305 (e.g., via the AIoT reader 308) and may verify the protected command response from the AIoT device 305 (e.g., received via the AIoT reader 308).

By using techniques as described in connection with FIG. 5, the message is protected using the protection key, which improves security between the AIoT device 305 and the AIoT controller 310. In some examples, the message may be encrypted using the confidentiality protection key, such that the message is protected from interception. In some examples, the message may be verified using the integrity protection key, such that AIoT controller 310 may detect and reject phony communications (e.g., to attack the AIoT controller 310 or otherwise corrupt data at the AF 402).

As indicated above, FIG. 5 is provided as an example. Other examples may differ from what is described with respect to FIG. 5.

FIG. 6 is a diagram illustrating an example process 600 performed, for example, at an AIoT device or an apparatus of an AIoT device, in accordance with the present disclosure. Example process 600 is an example where the apparatus or the AIoT device (e.g., AIoT device 305) performs operations associated with secure uplink communication in AIoT architecture.

As shown in FIG. 6, in some aspects, process 600 may include generating a protected message using a protection key, where the protection key is derived using a provisioned device credential and a key derivation parameter (block 610). For example, the AIoT device (e.g., using communication manager 806, depicted in FIG. 8) may generate a protected message using a protection key, where the protection key is derived using a provisioned device credential and a key derivation parameter, as described herein.

As further shown in FIG. 6, in some aspects, process 600 may include transmitting the protected message, via an AIoT reader, for delivery to an application function (block 620). For example, the AIoT device (e.g., using transmission component 804 and/or communication manager 806, depicted in FIG. 8) may transmit the protected message, via an AIoT reader, for delivery to an application function, as described herein.

Process 600 may include additional aspects, such as any single aspect or any combination of aspects described below and/or in connection with one or more other processes described elsewhere herein.

In a first aspect, the provisioned device credential includes a pairwise key or a group key.

In a second aspect, alone or in combination with the first aspect, the key derivation parameter includes a network ID, an ID associated with an AIoT controller, or a freshness parameter.

In a third aspect, alone or in combination with one or more of the first and second aspects, process 600 includes receiving (e.g., using reception component 802 and/or communication manager 806, depicted in FIG. 8) a request from the AIoT controller, where the protected message includes a response to the request.

In a fourth aspect, alone or in combination with one or more of the first through third aspects, process 600 includes decrypting and verifying (e.g., using communication manager 806) the request using the protection key.

In a fifth aspect, alone or in combination with one or more of the first through fourth aspects, the request includes a plaintext version of an ID associated with the AIoT device.

In a sixth aspect, alone or in combination with one or more of the first through fifth aspects, process 600 includes receiving (e.g., using reception component 802 and/or communication manager 806) the key derivation parameter in the request from the AIoT controller.

In a seventh aspect, alone or in combination with one or more of the first through sixth aspects, the key derivation parameter includes a freshness parameter, and the request includes a plaintext version of the freshness parameter.

In an eighth aspect, alone or in combination with one or more of the first through seventh aspects, the request includes an inventory request or a command request message.

In a ninth aspect, alone or in combination with one or more of the first through eighth aspects, the response includes an inventory response or a command response message.

In a tenth aspect, alone or in combination with one or more of the first through ninth aspects, the response includes a plaintext version of a freshness parameter received in the request and an additional freshness parameter generated by the AIoT device.

In an eleventh aspect, alone or in combination with one or more of the first through tenth aspects, a confidentiality protection key is generated from the protection key and an algorithm ID.

In a twelfth aspect, alone or in combination with one or more of the first through eleventh aspects, an integrity protection key is generated from the protection key and an algorithm ID.

In a thirteenth aspect, alone or in combination with one or more of the first through twelfth aspects, a security protection profile is configured to determine the algorithm ID.

In a fourteenth aspect, alone or in combination with one or more of the first through ninth aspects, the protected message is generated using the confidentiality protection key and freshness parameters.

In a fifteenth aspect, alone or in combination with one or more of the first through fourteenth aspects, an integrity protection key is generated from the protection key and an algorithm ID.

In a sixteenth aspect, alone or in combination with one or more of the first through fifteenth aspects, the freshness parameters comprise a counter, a time based counter, or a randomly generated number.

In a seventeenth aspect, alone or in combination with one or more of the first through sixteenth aspects, the protected message includes a plaintext of the freshness parameters.

In an eighteenth aspect, alone or in combination with one or more of the first through seventeenth aspects, the freshness parameters include a freshness parameter received in a request and an additional freshness parameter generated at the AIoT device.

In a nineteenth aspect, alone or in combination with one or more of the first through eighteenth aspects, the protected message includes a plaintext version of the ID associated with the AIoT device.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at an AIoT controller or an apparatus of an AIoT controller, in accordance with the present disclosure. Example process 700 is an example where the apparatus or the AIoT controller (e.g., AIoT controller 310) performs operations associated with secure uplink communication in AIoT architecture.

As shown in FIG. 7, in some aspects, process 700 may include receiving a protected message, via an AIoT reader, from an AIoT device (block 710). For example, the AIoT controller (e.g., using reception component 902 and/or communication manager 906, depicted in FIG. 9) may receive a protected message, via an AIoT reader, from an AIoT device, as described herein.

As further shown in FIG. 7, in some aspects, process 700 may include generating a verified message, from the protected message, using a protection key, where the protection key is derived using a provisioned device credential and a key derivation parameter (block 720). For example, the AIoT controller (e.g., using communication manager 906) may generate a verified message, from the protected message, using a protection key, where the protection key is derived using a provisioned device credential and a key derivation parameter, as described herein.

As further shown in FIG. 7, in some aspects, process 700 may include transmitting the verified message to an application function (block 730). For example, the AIoT controller (e.g., using transmission component 904 and/or communication manager 906, depicted in FIG. 9) may transmit the verified message to an application function, as described herein.

Process 700 may include additional aspects, such as any single aspect or any combination of aspects described below and/or in connection with one or more other processes described elsewhere herein.

In a first aspect, the provisioned device credential includes a pairwise key or a group key.

In a second aspect, alone or in combination with the first aspect, the key derivation parameter includes a network ID, an ID associated with an AIoT controller, or a freshness parameter.

In a third aspect, alone or in combination with one or more of the first and second aspects, process 700 includes transmitting (e.g., using transmission component 904 and/or communication manager 906) a request to the AIoT device, where the protected message includes a response to the request.

In a fourth aspect, alone or in combination with one or more of the first through third aspects, process 700 includes encrypting (e.g., using communication manager 906) the request using the protection key.

In a fifth aspect, alone or in combination with one or more of the first through fourth aspects, the request includes a plaintext version of an ID associated with the AIoT device.

In a sixth aspect, alone or in combination with one or more of the first through fifth aspects, the request includes a plaintext version of a freshness parameter.

In a seventh aspect, alone or in combination with one or more of the first through sixth aspects, the request includes an inventory request or a command request message.

In an eighth aspect, alone or in combination with one or more of the first through seventh aspects, the response includes an inventory response or a command response message.

In a ninth aspect, alone or in combination with one or more of the first through eighth aspects, the response includes a plaintext version of a freshness parameter transmitted in the request and an additional freshness parameter generated by the AIoT device.

In a tenth aspect, alone or in combination with one or more of the first through ninth aspects, the command is associated with a counter or an expiry time.

In an eleventh aspect, alone or in combination with one or more of the first through tenth aspects, a confidentiality protection key is generated from the protection key and an algorithm ID.

In a twelfth aspect, alone or in combination with one or more of the first through eleventh aspects, an integrity protection key is generated from the protection key and an algorithm ID.

In a thirteenth aspect, alone or in combination with one or more of the first through twelfth aspects, a security protection profile is configured to determine the algorithm ID.

In a fourteenth aspect, alone or in combination with one or more of the first through thirteenth aspects, the verified message is generated based at least in part on the confidentiality protection key and freshness parameters.

In a fifteenth aspect, alone or in combination with one or more of the first through fourteenth aspects, a message authentication code is generated using the integrity protection key and freshness parameters.

In a sixteenth aspect, alone or in combination with one or more of the first through fifteenth aspects, the freshness parameters comprise a counter, a time based counter, or a randomly generated number.

In a seventeenth aspect, alone or in combination with one or more of the first through fifteenth aspects, the protected message includes a plaintext of the freshness parameters.

In an eighteenth aspect, alone or in combination with one or more of the first through seventeenth aspects, the freshness parameters include a freshness parameter transmitted in a request and an additional freshness parameter generated at the AIoT device.

In a nineteenth aspect, alone or in combination with one or more of the first through eighteenth aspects, the protected message includes a plaintext version of an ID associated with the AIoT device.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a AIoT device, or a AIoT device may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 3. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 4-5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the AIoT device described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, one or more modems, one or more demodulators, one or more MIMO detectors, one or more receive processors, one or more controllers/processors, one or more memories, or a combination thereof, of the AIoT device described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, one or more modems, one or more modulators, one or more transmit MIMO processors, one or more transmit processors, one or more controllers/processors, one or more memories, or a combination thereof, of the AIoT device described in connection with FIG. 2. In some aspects, the transmission component 804 may be co-located with the reception component 802 in one or more transceivers.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

In some aspects, the communication manager 806 may generate a protected message using a protection key, and the protection key may be derived using a provisioned device credential and a key derivation parameter. The transmission component 804 may transmit the protected message, via an AIoT reader, for delivery to an application function.

In some aspects, the reception component 802 may receive a request from the AIoT controller. Accordingly, the protected message may include a response to the request. In some aspects, the communication manager 806 may decrypt and verify the request using the protection key. In some aspects, the reception component 802 may receive the key derivation parameter in the request.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a AIoT controller, or a AIoT controller may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 3. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the AIoT controller described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the AIoT controller described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the AIoT controller described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

In some aspects, the reception component 902 may receive a protected message, via an AIoT reader, from an AIoT device. The communication manager 906 may generate a verified message, from the protected message, using a protection key, and the protection key is derived using a provisioned device credential and a key derivation parameter. The transmission component 904 may transmit the verified message to an application function.

In some aspects, the transmission component 904 may transmit a request to the AIoT device. The request may include the key derivation parameter. Accordingly, the protected message may include a response to the request. In some aspects, the communication manager 906 may encrypt the request using the protection key.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by an ambient Internet of Things (AIoT) device, comprising: generating a protected message using a protection key, wherein the protection key is derived using a provisioned device credential and a key derivation parameter; and transmitting the protected message, via an AIoT reader, for delivery to an application function.

Aspect 2: The method of Aspect 1, wherein the provisioned device credential comprises a pairwise key or a group key.

Aspect 3: The method of any of Aspects 1-2, wherein the key derivation parameter comprises a network identifier (ID), an ID associated with an AIoT controller, or a freshness parameter.

Aspect 4: The method of any of Aspects 1-3, further comprising: receiving a request from the AIoT controller, wherein the protected message comprises a response to the request.

Aspect 5: The method of Aspect 4, further comprising: decrypting and verifying the request using the protection key.

Aspect 6: The method of any of Aspects 4-5, wherein the request includes a plaintext version of an identifier (ID) associated with the AIoT device.

Aspect 7: The method of any of Aspects 4-6, further comprising: receiving the key derivation parameter in the request.

Aspect 8: The method of Aspect 7, wherein the key derivation parameter comprises a freshness parameter, and the request includes a plaintext version of the freshness parameter.

Aspect 9: The method of any of Aspects 6-8, wherein the request comprises an inventory request or a command request message.

Aspect 10: The method of any of Aspects 6-9, wherein the response comprises an inventory response or a command response message.

Aspect 11: The method of any of Aspects 6-10, wherein the response includes a plaintext version of a freshness parameter received in the request and an additional freshness parameter generated by the AIoT device.

Aspect 12: The method of any of Aspects 1-11, wherein a confidentiality protection key is generated from the protection key and an algorithm identifier (ID).

Aspect 13: The method of Aspect 12, wherein a security protection profile is configured to determine the algorithm ID.

Aspect 14: The method of any of Aspects 12-13, wherein the protected message is generated using the confidentiality protection key and freshness parameters.

Aspect 15: The method of Aspect 14, wherein the freshness parameters comprise a counter, a time based counter, or a randomly generated number.

Aspect 16: The method of any of Aspects 14-15, wherein the protected message includes a plaintext of the freshness parameters.

Aspect 17: The method of any of Aspects 14-16, wherein the freshness parameters comprise a freshness parameter received in a request and an additional freshness parameter generated at the AIoT device.

Aspect 18: The method of any of Aspects 1-17, wherein an integrity protection key is generated from the protection key and an algorithm identifier (ID).

Aspect 19: The method of Aspect 18, wherein a security protection profile is configured to determine the algorithm ID.

Aspect 20: The method of any of Aspects 18-19, wherein a message authentication code is generated using the integrity protection key and freshness parameters.

Aspect 21: The method of Aspect 20, wherein the freshness parameters comprise a counter, a time based counter, or a randomly generated number.

Aspect 22: The method of any of Aspects 20-21, wherein the protected message includes a plaintext of the freshness parameters.

Aspect 23: The method of any of Aspects 20-22, wherein the freshness parameters comprise a freshness parameter received in a request and an additional freshness parameter generated at the AIoT device.

Aspect 24: The method of any of Aspects 1-23, wherein the protected message includes a plaintext version of an identifier (ID) associated with the AIoT device.

Aspect 25: A method of wireless communication performed by an ambient Internet of Things (AIoT) controller, comprising: receiving a protected message, via an AIoT reader, from an AIoT device; generating a verified message, from the protected message, using a protection key, wherein the protection key is derived using a provisioned device credential and a key derivation parameter; and transmitting the verified message to an application function.

Aspect 26: The method of Aspect 25, wherein the provisioned device credential comprises a pairwise key or a group key.

Aspect 27: The method of any of Aspects 25-26, wherein the key derivation parameter comprises a network identifier (ID), an ID associated with an AIoT controller, or a freshness parameter.

Aspect 28: The method of any of Aspects 25-27, further comprising: transmitting a request to the AIoT device, wherein the protected message comprises a response to the request.

Aspect 29: The method of Aspect 28, further comprising: encrypting the request using the protection key.

Aspect 30: The method of any of Aspects 28-29, wherein the request includes a plaintext version of an identifier (ID) associated with the AIoT device.

Aspect 31: The method of any of Aspects 28-30, wherein the request includes a plaintext version of a freshness parameter.

Aspect 32: The method of any of Aspects 28-31, wherein the request comprises an inventory request or a command request message.

Aspect 33: The method of any of Aspects 28-32, wherein the response comprises an inventory response or a command response message.

Aspect 34: The method of any of Aspects 28-33, wherein the response includes a plaintext version of a freshness parameter transmitted in the request and an additional freshness parameter generated by the AIoT device.

Aspect 35: The method of any of Aspects 22-34, wherein the request is associated with a counter or an expiry time.

Aspect 36: The method of any of Aspects 19-35, wherein a confidentiality protection key is generated from the protection key and an algorithm identifier (ID).

Aspect 37: The method of Aspect 36, wherein a security protection profile is configured to determine the algorithm ID.

Aspect 38: The method of any of Aspects 36-37, wherein the verified message is generated based at least in part on the confidentiality protection key and freshness parameters.

Aspect 39: The method of Aspect 38, wherein the freshness parameters comprise a counter, a time based counter, or a randomly generated number.

Aspect 40: The method of any of Aspects 38-39, wherein the protected message includes a plaintext of the freshness parameters.

Aspect 41: The method of any of Aspects 38-40, wherein the freshness parameters comprise a freshness parameter transmitted in a request and an additional freshness parameter generated at the AIoT device.

Aspect 42: The method of any of Aspects 19-41, wherein an integrity protection key is generated from the protection key and an algorithm identifier (ID).

Aspect 43: The method of Aspect 42, wherein a security protection profile is configured to determine the algorithm ID.

Aspect 44: The method of any of Aspects 42-43, wherein a message authentication code is generated using the integrity protection key and freshness parameters.

Aspect 45: The method of Aspect 44, wherein the freshness parameters comprise a counter, a time based counter, or a randomly generated number.

Aspect 46: The method of any of Aspects 44-45, wherein the protected message includes a plaintext of the freshness parameters.

Aspect 47: The method of any of Aspects 44-46, wherein the freshness parameters comprise a freshness parameter transmitted in a request and an additional freshness parameter generated at the AIoT device.

Aspect 48: The method of any of Aspects 19-47, wherein the protected message includes a plaintext version of an identifier (ID) associated with the AIoT device.

Aspect 37: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-48

Aspect 38: An apparatus for wireless communication at a device, the apparatus comprising one or more memories and one or more processors coupled to the one or more memories, the one or more processors configured to cause the device to perform the method of one or more of Aspects 1-48.

Aspect 39: An apparatus for wireless communication, the apparatus comprising at least one means for performing the method of one or more of Aspects 1-48.

Aspect 40: A non-transitory computer-readable medium storing code for wireless communication, the code comprising instructions executable by one or more processors to perform the method of one or more of Aspects 1-48.

Aspect 41: A non-transitory computer-readable medium storing a set of instructions for wireless communication, the set of instructions comprising one or more instructions that, when executed by one or more processors of a device, cause the device to perform the method of one or more of Aspects 1-48.

Aspect 42: A device for wireless communication, the device comprising a processing system that includes one or more processors and one or more memories coupled with the one or more processors, the processing system configured to cause the device to perform the method of one or more of Aspects 1-48.

Aspect 43: An apparatus for wireless communication at a device, the apparatus comprising one or more memories and one or more processors coupled to the one or more memories, the one or more processors individually or collectively configured to cause the device to perform the method of one or more of Aspects 1-48.

Aspect 44: A device comprising a processing system that includes one or more processors and one or more code-storing memories coupled with the one or more processors, the processing system configured to cause the device to perform the method of one or more of Aspects 1-48.

Aspect 45: A device comprising a processing system that includes processor circuitry and code-storing memory circuitry, the processing system configured to cause the device to perform the method of one or more of Aspects 1-48.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a +b, a+a+c, a+b+b, a+c+c, b+b, b+b+b, b +b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An ambient Internet of Things (AIoT) device, comprising:
a processing system that includes one or more processors and one or more code-storing memories coupled with the one or more processors, the processing system configured to cause the AIoT device to:
generate a protected message using a protection key, wherein the protection key is derived using a provisioned device credential and a key derivation parameter; and
transmit the protected message, via an AIoT reader, for delivery to an application function.

2. The AIoT device of claim 1, wherein the provisioned device credential comprises a pairwise key or a group key.

3. The AIoT device of claim 1, wherein the key derivation parameter comprises a network identifier (ID), an ID associated with an AIoT controller, or a freshness parameter.

4. The AIoT device of claim 1, wherein the processing system is configured to cause the AIoT device to:
receive a request from the AIoT controller,
wherein the protected message comprises a response to the request.

5. The AIoT device of claim 4, wherein the processing system is configured to cause the AIoT device to:
decrypt and verify the request using the protection key.

6. The AIoT device of claim 4, wherein the request includes a plaintext version of an identifier (ID) associated with the AIoT device.

7. The AIoT device of claim 4, wherein the processing system is configured to cause the AIoT device to:
receive the key derivation parameter in the request.

8. The AIoT device of claim 7, wherein the key derivation parameter comprises a freshness parameter, and the request includes a plaintext version of the freshness parameter.

9. The AIoT device of claim 1, wherein the request comprises an inventory request or a command request message.

10. The AIoT device of claim 1, wherein the response comprises an inventory response or a command response message.

11. The AIoT device of claim 1, wherein the response includes a plaintext version of a freshness parameter received in the request and an additional freshness parameter generated by the AIoT device.

12. The AIoT device of claim 1, wherein a confidentiality protection key is generated from the protection key and an algorithm ID.

13. The AIoT device of claim 12, wherein the protected message is generated using the confidentiality protection key and freshness parameters.

14. The AIoT device of claim 1, wherein an integrity protection key is generated from the protection key and an algorithm ID.

15. The AIoT device of claim 14, wherein a message authentication code is generated using the integrity protection key and freshness parameters.

16. The AIoT device of claim 15, wherein the protected message includes a plaintext of the freshness parameters.

17. The AIoT device of claim 15, wherein the freshness parameters comprise a freshness parameter received in a request and an additional freshness parameter generated at the AIoT device.

18. The AIoT device of claim 1, wherein the protected message includes a plaintext version of an identifier (ID) associated with the AIoT device.

19. A method of wireless communication performed by an ambient Internet of Things (AIoT) device, comprising:
generating a protected message using a protection key, wherein the protection key is derived using a provisioned device credential and a key derivation parameter; and
transmitting the protected message, via an AIoT reader, for delivery to an application function.

20. A non-transitory computer-readable medium storing a set of instructions for wireless communication, the set of instructions comprising:
one or more instructions that, when executed by one or more processors of an ambient Internet of Things (AIoT) device, cause the AIoT device to:
generate a protected message using a protection key, wherein the protection key is derived using a provisioned device credential and a key derivation parameter; and
transmit the protected message, via an AIoT reader, for delivery to an application function.
